(19) United States
(12) Patent Application Publication
(10) Pub. No.: US 2007/0111841 A1
(43) Pub. Date: May 17, 2007

(54) Axle assembly bearing positioning and preload adjustment tool and method of implementing same

(76) Inventor: Todd A. Smith, Fort Wayne, IN (US)

Correspondence Address: BERENATO, WHITE & STAVISH, 6550 ROCK SPRING DRIVE, SUITE 240, BETHESDA, MD, 20817, US

(21) Appl. No.: 11/583,132

(22) Filed: Oct. 19, 2006

Related U.S. Application Data
(60) Provisional application No. 60/727,861, filed on Oct. 19, 2005.

(51) Int. Cl. F16H 48/06

(52) U.S. Cl. 475/230

(57) ABSTRACT

An axle assembly bearing preload positioning and load adjustment device and associated method. A differential case 51 is rotatably supported in a housing by a pair of bearing assemblies. A pair of threaded adjusters having a substantially cylindrical body are each disposed within and threadingly engage the housing for selectively positioning the case 51 relative to the housing. The adjusters each include gear teeth for engaging a rotatable tool to facilitate both position a and bearing preload. The threaded adjusters are simultaneously adjustable to provide for either selective positioning of the differential case 51 relative to the housing or establishing a preload to said bearing assemblies. The tool head may be automatically controlled with an electronically controlled indexing machine.

This application claims the benefit of U.S. provisional application Ser. No. 60/727,861 filed on Oct. 19, 2005 and is hereby incorporated herein by reference.

### BACKGROUND OF THE INVENTION

1. Field of the Invention

The present invention relates to the adjustment of a bearing support in a differential assembly and more particularly to threaded adjuster for adjusting preload and setting the differential case.

2. Discussion of the Related Art

There has been a long felt need in the art for threaded adjusters for differential bearing pre-load and the setting of the differential case. Many differentials have been made with no way to adjust bearing pre-load or setting the case other than to assemble the differential with a prescribed number of shims and then check the ring and pinion alignment, if the alignment is incorrect, the differential must be disassembled, the shims changed and the differential reassembled. This type of pre-load adjustment system can be very time consuming, costly and frustrating for the person doing the assembly. An alternative to shims and trial and error are threaded adjusters. However, the current generation of threaded adjusters has caused many artisans to have less than a proactive approach in implementing them. Currently, the only way to adjust the threaded adjusters present in the art is to go into the tube bore with a driver or modify the carrier casting with a window that would allow the use of a spanner type wrench for adjustment through the cover plate opening. These current adjustment devices are difficult and time consuming to use especially in a Salisbury type axle assembly. The following references are each incorporated herein by reference: U.S. Pat. Nos. 6,532,660; 5,947,252; 6,318,201; 6,478,709; 6,357,927; 6,595,085; 5,624,345; 6,736,544; 6,318,201; 6,093,127; 6,088,910; 6,000,134; 5,806,371; 5,579,570; 5,115,558; 4,406,179.

### SUMMARY OF THE INVENTION

The present invention is directed to a motor vehicle differential axle assembly. The assembly includes a differential case driven by an input shaft and having a gear assembly disposed therein for allowing differential speed rotation between a pair of output shafts. The case is rotatably supported in a housing by a pair of bearing assemblies. The bearing assemblies are disposed about a respective one of the shafts. The housing includes an opening to provide access therein. A pair of threaded adjusters having a substantially cylindrical body are disposed within and threadingly engaging the housing. The threaded adjusters each are selectively positionable along a central axis by selective relative rotation relative to the housing. The cylindrical bodies each include gear teeth positioned proximate the opening of the housing for engaging a rotatable tool to facilitate selective positioning. The threaded adjusters are each positioned between the housing and a respective one of the bearing assemblies. The threaded adjusters are simultaneously adjustable to provide for either selective positioning of the differential case relative to the housing or establishing a preload to said bearing assemblies.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a sectional view of a differential housing assembly incorporating the present invention with the preload/setting adjuster installed into the differential housing.

FIG. 2 is an isolated view of the engagement of the rotary tool head and gearing of the adjuster according to an alternate embodiment employing a beveled gear.

FIG. 3 is a side view of the rotary tool engaging he threaded adjuster of FIG. 2.

FIG. 4 is a schematic view of an indexing machine with dual rotary tool heads.

FIG. 5 is an isolated partial exposed view of a differential axle assembly with threaded adjuster disposed between the housing and case bearings.

### DESCRIPTION OP THE PREFERRED EMBODIMENT

The present invention is directed to a bearing adjuster 1 for a differential. The threaded adjuster 1 is a cylindrical body having threads 3 on the outer surface which engage corresponding teeth/threads 5 formed in the axle housing 7. The adjuster 1 also has a ring of gears 9 preferably spur gears, on the outer diameter of the adjuster 1. A bearing thrust surface 11 is provided to seat a set of bearings 31 to rotatably support components of the axle assembly. Bevel gear teeth or helical or splined teeth may also be employed. In the beveled gear embodiment, the teeth are similar to the kind found on a drill chuck or side gear, commonly referred to as bevel gear type teeth. The carrier housing 7 includes a removable cover (not shown) exposing an opening to access the gear face 9 of the threaded adjuster. This allows for a rotary tool 21 to be inserted perpendicular to the rotation of the treaded adjuster 3 with sufficient clearance.

In order to set the differential case 51, and or establish the bearing preload, the rotary tool 21 equipped with a drive head 23 to engage the teeth 9 in the adjuster 1, is inserted through the housing opening until it mates with the gear teeth 9 on the adjuster 3. As the rotary tool/gear head rotates, the threaded adjuster 1 rotates within the housing 7 which causes the adjuster 1 to move axially relative to the housing 1. The tool/gear head 23 may be rotated in either direction to cause axial/longitudinal displacement of the threaded adjuster 1 in either direction along axis 13. The tool 21 is simply rotated until either the adjuster 1 is in a proper position or bearing preload is established.

Dual rotary tools 21a 21 may be employed to simultaneously engage opposite adjusters (only one shown) during the installation of the differential case 51. Once the axle assembly is loosely assembled, the rotary tool heads 21a, 21b will engage the adjusters 1 and rotate according to properly set the axle assembly. Position sensors 25 (schematically shown in FIG. 4) may be employed to sense the position of the differential case 51 and sent to a controller 27 which in turn controls the rotary movement of each tool head 21a, 21b and thus control the rotation of the adjuster 1. A simple control algorithm may be employed to properly control the rotation of the rotary heads 21a, 21b to obtain the desired setting of the differential case 51. Off course, the rotary tool 21 may be individually and manually manipulated to set/locate the differential case 51. In either method, the use of a continuously engaging tool with the threaded adjuster 1 by a rotary gear head 21 eliminates the use of a cumbersome spanner wrench.

Once the differential case 51 is set in the housing 7 and the tubes pressed, the differential bearing pre-load may be established. Thus this system will allow the Assembly Department to set the pre-load after the tubes have been pressed into the carrier 7. Furthermore, bearing preload may be simply reset at any time during maintenance. The housing cover simply need be removed to expose the gearing 9 of the adjuster 1 and engaged with the gear head 23 of the rotary tool 21.

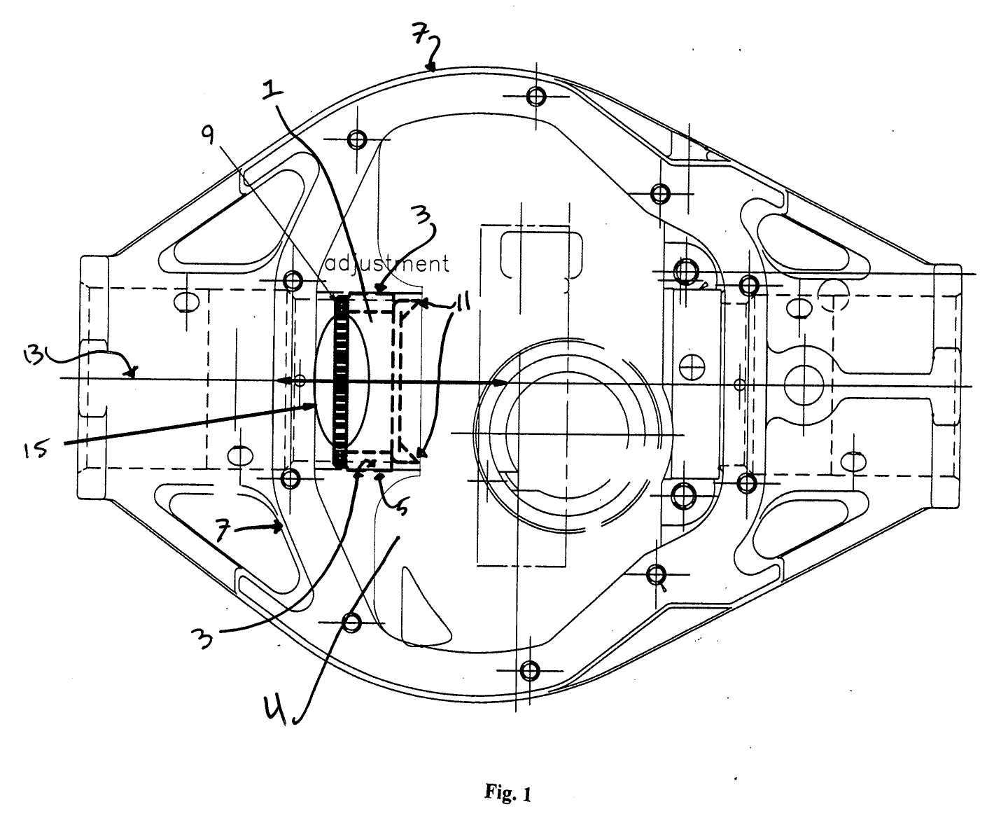

FIG. 1 depicts a differential housing 7 with a threaded adjuster 1 threadingly engaging the housing 7 in a corresponding threaded portion 5 formed in the housing. A window 15 may be cut in the threaded portion of the housing 5 to allow exposure of the geared portion 9. With the cover removed, a simply rotary tool 21 may be inserted to engage the gearing 9 of the adjuster 1 such that rotation of the tool head 21 will cause the adjuster 1 to rotate and translate longitudinally along axis 13 within the housing 7. A second adjuster is preferably disposed on the opposite side of the housing 7 in a similar fashion (Adjuster not shown) that will facilitate setting of the differential case 51 by selective adjustment of each threaded adjuster 1.

FIG. 2 depicts an isolated view of the threaded adjuster 1 and rotary tool head 23. In this embodiment a beveled gear is employed much like the chuck of a drill. The rotary tool head 23 is simply inserted perpendicular to the axis of the adjuster 3. Rotation of the tool head 23 will cause the adjuster 1 to rotate relative to the housing 7 to facilitate precise location of the adjuster 3 along the longitudinal axis 13 of the adjuster 1 and axle assembly.

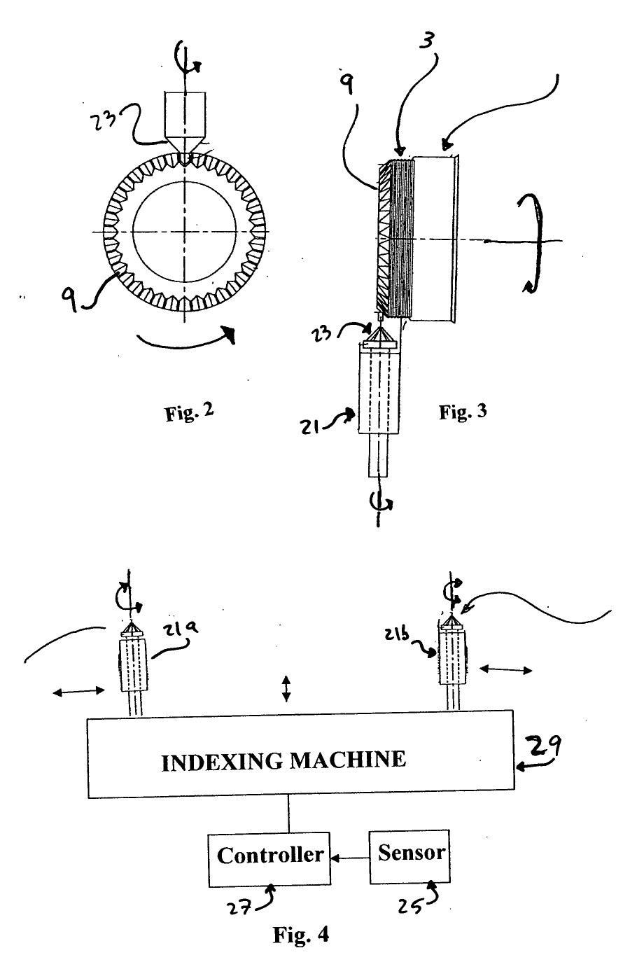

FIG. 3 is an isolated side view showing the engagement of the rotary tool head 23 with the bevel gears formed on the outer diameter of the adjuster 1.

FIG. 4 depicts a schematic view of the rotary too head 21 with associated indexing machine 29. Two rotary tools 21a, 21b are controllably movably mounted to an indexing machine 29. The indexing machine 29 is controllably movable relative to the differential housing 7. Once the differential assembly is loosely assembled, the indexing machine 29 is moved such that the rotary heads 21a, 21b engage an associated one of the two gears of the adjusters 1. Coordinated movement of the rotary tool head 21 relative to the indexing machine 29 and the indexing machine 29 itself is controlled electronically or manually until the rotary too head 23 engages the adjuster 1. A plurality of position sensors 25 and load sensors (not shown) may be employed to automatically control the movement of the indexing machine 29 and rotary displacement and rotary movement of the tool heads 21a, 21b. The rotary heads 21a, 21b are first rotated in coordinated fashion to position or set the differential case 51 relative to the housing 7 which can be done manually or controlled by algorithm in response to sensed conditions. Once the differential case 51 is set, the rotary heads 23a, 23b are rotated to achieve the desisted bearing preload.

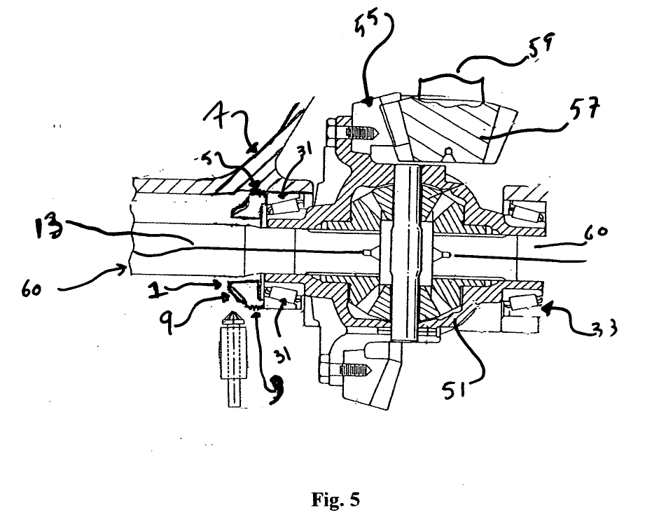

FIG. 5 depicts a treaded adjuster 31 disposed between a bearing assembly 31 and the housing 7. It is noted that only one threaded adjuster 1 is show. However, a second threaded adjuster is employed between the opposite bearing 33 assembly and the housing 7 in an identical fashion. The threaded adjuster 1 is formed of a substantially cylindrical body having threads 3 which engage corresponding threads 5 formed on the internal surface of the housing 7. Simple rotation of the threaded adjuster 1 causes the cylindrical body to translate along a common central axis 13 concentric about the output shaft 60. Thy threaded adjuster 1 includes a beveled gear 9 surface for engaging a corresponding beveled gear tool head 23. The tool head is inserted to engage the beveled gear teeth 9 of the adjuster 1. Rotation of the tool head 21 causes the adjuster 1 to rotate about its axis 13. Rotation of the threaded adjuster 1 in turn causes the adjuster 1 to translate along its axis 13 and move relative to the housing 7 by virtue of the threaded engagement with the housing 7. The tool head 21 may be rotated in either directed to cause the adjuster 1 to move into and out of engagement with the outer race of the bearing assembly 31. As the adjuster 1 moves towards the right, the adjuster will increasingly bear against the bearing assembly 31. One of ordinary skill in the art will recognize that coordinated movement of the two tool heads 21 thereby causes substantially identical rotation of the two threaded adjusters 1 which will cause the differential assembly (case 51) to translate parallel to/along the central axis 13 and thereby be selectively positioned to a predetermined positioned relative to the housing 7. Simple inspection of the assembly of FIG. 5 reveals that the case 51 may be displaced for selectively positioning and the ring gear 55 in desirable engagement with the pinion gear 57 of the input shaft 59. The present invention contemplates initially installing the threaded adjusters 1 in a position widest apart from one another. A different case 51 with gear assembly is then roughly set in the housing 7. Each of the threaded adjusters 1 is then selectively rotated to engage a corresponding bearing assembly 31, 33. The mating tool heads 21a, 21b may then be rotated in a coordinated fashion to simultaneously rotate the threaded adjusters 1 thereby displacing the entire case 51 assembly without significantly affecting bearing preload. Once the differential case 51 is positioned to a desired position, the mating tool heads 23a, 23b are again selectively rotated to establish a predetermined preload to the bearing assemblies 31, 33. Often the mating tool heads 21a, 21b are rotated to cause the threaded adjusters 1 to each translate inward thereby increasing bearing preload without changing the position of the differential case 51. Of course, the tool heads 21a, 21b can be controllably rotated to reduce a load on the bearing assemblies 31, 33 as well. As previously mentioned each of the rotating mating tool heads 21a, 21b are supported and rotatably driven by a common indexing machine 29. Supporting rotatable tool heads on a common indexing machine is understood to those of skill in the art and need no be elaborated. The two mating tools 21a, 21b simply need to be selectively displaceable relative to one another and selectively rotated on a common supporting tool 29. The supporting tool 29 then simply needs to be able to move in a controlled fashion. Coordinated movement of such tool heads 21 on indexing machines 29 will be readily apparently top those skilled in the art thus enabling one to employ the present invention. The indexing machine 29 and rotation of the mating tools heads 21a, 21b are then controlled to establish the proper position of the case 51 and bearing preload. For automatic operation, an electronic controller 27 may be employed to process signals from a plurality of position sensors 25 sensing the relative position of the case 51 assembly relative to the housing 7 and pinion gear 57 as well as the location of the indexing machine 27 and mating tool head 21 relative to the housing 7. Off course manual control of the index machine 29 may also be employed. Load sensors (not shown) may also be employed for precisely sensing the preload in the bearing assemblies. In such instance, the controller processes signals from conventional load sensors and controls rotation of the mating tool heads 21a, 21b and consequently displacement of the threaded adjusters 1 until a desired preload is established. Such load sensors are known to those skilled in the art and need not be discussed further.

While the foregoing invention has been shown and described with reference to a preferred embodiment, it will be understood by those possessing skill in the art that various changes and modifications may be made without departing from the spirit and scope of the invention. For example, as depicted in FIGS. 2-3, a bevel gear engagement is how. However, it is to be understood that spur gears may also be employed. In such instance to rotational axis of the tool head will shift ninety degrees. These and other departures are considered within the spirit and scope of the invention.

1. A motor vehicle differential axle assembly, comprising:
a motor vehicle differential case driven by an input shaft and having a gear assembly disposed therein for allowing differential speed rotation between a pair of output shafts, said case being rotatably supported in a housing through a pair of bearing assemblies; said bearing assemblies being disposed about a respective one of said output shafts, said housing having an opening providing access within said housing; and
a pair of threaded adjusters having a substantially cylindrical body disposed within and threadingly engaging said housing, said threaded adjusters each being selectively positionable along a central axis by selective relative rotation relative to said housing, said substantially cylindrical bodies each having gear teeth disposed on a surface thereof positioned proximate said opening of said housing for engaging a rotatable tool to thereby facilitate selective positioning relative to said housing, said pair of threaded adjusters being one each positioned between said housing and a respective one of said pair of bearing assemblies, each of said threaded adjusters provided for simultaneous adjustment to facilitate one of selective positioning of said differential case relative to said housing and establishing a preload to said bearing assemblies.

2. The axle assembly according to claim 1, wherein simultaneous rotation of said pair of threaded adjusters causes displacement of said case relative to said housing along said axis.

3. The differential axle assembly according to claim 1 in combination with a pair of mating tools each having a drive head, said drive heads simultaneously engaging said pair of threaded adjusters, wherein said mating tools are independently selectively movable within said opening of said housing while engaging said adjusters 1 such that coordinated rotation and translational movement of said mating tools causes selective controlled rotation of said cylindrical bodies relative to said housing to selectively position said case relative to said housing and establish a predetermined preload to said pair of bearing assemblies.

4. The backlash adjuster according to claim 3, wherein said teeth of said cylindrical body are bevel gear teeth adapted to cooperatively engage bevel gear teeth of said drive heads of said mating tools, said mating tools being disposed on a common movable index machine, wherein each of said tools are independently movable relative to said indexing machine and movement of said indexing machine causes coordinated simultaneous movement of said mating tools.

5. The backlash adjuster according to claim 3, wherein said teeth of said cylindrical body are one of a helical and spur gear adapted to cooperatively engage one of a helical and spur gear of said drive heads of said mating tools, said mating tools being disposed on a common movable index machine, wherein each of said tools are independently movable relative to said indexing machine and movement of said indexing machine causes coordinated simultaneous movement of said mating tools.

6. The axle assembly according to claim 3 further comprising:
a common movable index machine independently supporting each of said mating tools, said mating tools further being independently movable relative to said indexing machine; and
a sensor assembly including a plurality of positioned sensors to sense a position of said case relative to said housing;
a load sensor mechanism to sense a preload on said bearings;
a controller selectively controlling coordinated movement of said indexing machine and said mating tool heads to thereby automatically selectively position said case relative to said housing and establish a predetermined preload to said bearings.
